(19) United States
(12) Patent Application Publication
(10) Pub. No.: US 2017/0120444 A1
(43) Pub. Date: May 4, 2017

(54) ROBOT, CONTROL APPARATUS, AND ROBOT SYSTEM

(71) Applicant: Seiko Epson Corporation, Tokyo (JP)

(72) Inventors: Masaki MOTOYOSHI, Azumino (JP); Ryosuke IMAI, Matsumoto (JP)

(21) Appl. No.: 15/340,232

(22) Filed: Nov. 1, 2016

(30) Foreign Application Priority Data
Nov. 2, 2015 (JP) 2015-215650

(51) Int. Cl. B25J 9/16; B25J 9/00; B25J 13/08

(52) U.S. Cl. CPC B25J 9/1638; B25J 13/088; B25J 9/0018

(57) ABSTRACT

A robot includes a first arm rotatable about a first rotation axis, a second arm provided to be rotatable about a second rotation axis in a axis direction different from a axis direction of the first rotation axis, and inertial sensors, wherein the first arm and the second arm can overlap as seen from the axis direction of the second rotation axis.

### BACKGROUND

1. Technical Field

The present invention relates to a robot, a control apparatus, and a robot system.

2. Related Art

In related art, robots with robot arms are known. In the robot arm, a plurality of arms (arm members) are coupled via joint parts and, as an end effector, e.g. a hand is attached to the arm on the most distal end side (on the most downstream side). The joint parts are driven by motors and the arms rotate by the driving of the joint parts. Then, for example, the robot grasps an object with the hand, moves the object to a predetermined location, and performs predetermined work such as assembly.

As the robot, Patent Document 1 (JP-A-2014-46401) discloses a vertical articulated robot. The robot described in Patent Document 1 is adapted, when moving a hand with respect to a base to a position different by 180° about a first rotation axis as a rotation axis (rotation axis extending in vertical directions) on the most proximal end side (on the most upstream side), to rotate a first arm as an arm on the most proximal end side (base side) with respect to the base about the first rotation axis.

In the robot described in Patent Document 1, when the hand is moved to the position different by 180° about the first rotation axis with respect to the base, a large space for preventing interferences of the robot is required.

### SUMMARY

An advantage of some aspects of the invention is to solve at least a part of the problems described above, and the can be implemented as the following configurations.

A robot according to an aspect of the invention includes an nth (n is an integer equal to or more than one) arm rotatable about an nth rotation axis, an (n+1)th arm provided on the nth arm to be rotatable about an (n+1)th rotation axis in a axis direction different from a axis direction of the nth rotation axis, and a first inertial sensor, wherein the nth arm and the (n+1)th arm can overlap as seen from the axis direction of the (n+1)th rotation axis.

According to the robot, the nth arm and the (n+1)th arm can overlap as seen from the axis direction of the (n+1)th rotation axis, and a space for preventing interferences of the robot may be made smaller. Further, vibrations of the robot may be reduced based on output of the first inertial sensor.

In the robot according to the aspect of the invention, it is preferable that a length of the nth arm is longer than a length of the (n+1)th arm.

With this configuration, the robot in which the nth arm and the (n+1)th arm can overlap as seen from the axis direction of the (n+1)th rotation axis while interferences between the nth arm and the (n+1)th arm are avoided may be realized.

In the robot according to the aspect of the invention, it is preferable that a base is provided, wherein the nth (n is one) arm is provided on the base to be rotatable about the nth rotation axis.

With this configuration, the nth arm and the (n+1)th arm may be rotated with respect to the base.

In the robot according to the aspect of the invention, it is preferable that the first inertial sensor is provided in the nth arm.

With this configuration, the vibration of the nth arm may be detected with higher accuracy using the output of the first inertial sensor. Accordingly, the vibration of the nth arm may be reduced by relatively simple control based on the output of the first inertial sensor. Here, generally, the vibrations on the distal end side of the robot arm including the nth arm and the (n+1)th arm are more readily affected by the vibrations of the arms on the more proximal end side about the rotation axis. Accordingly, to reduce the vibration of the distal end of the robot arm, preferential reduction of the vibrations of the arms on the more distal end side is effective.

In the robot according to the aspect of the invention, it is preferable that a second inertial sensor is provided in the (n+1)th arm.

With this configuration, the vibration of the (n+1)th arm may be reduced by relatively simple control based on output of the second inertial sensor.

In the robot according to the aspect of the invention, it is preferable that an (n+2)th arm is provided on the (n+1)th arm to be rotatable about an (n+2)th rotation axis in a axis direction parallel to the axis direction of the (n+1)th rotation axis, and a second inertial sensor is provided in the (n+2)th arm.

With this configuration, vibrations of the (n+1)th arm and the (n+2)th arm may be reduced based on the output of the second inertial sensor.

In the robot according to the aspect of the invention, it is preferable that the first inertial sensor has a detection axis in an axis direction parallel to the axis direction of the nth rotation axis.

With this configuration, for example, in the case where an angular velocity sensor is used as the first inertial sensor, the vibration of the nth arm about the nth rotation axis may be detected with higher accuracy using the output of the first inertial sensor. Accordingly, the vibrations of the robot may be efficiently reduced.

In the robot according to the aspect of the invention, it is preferable that the first inertial sensor is an angular velocity sensor.

With this configuration, the vibration of the nth arm about the nth rotation axis may be detected with higher accuracy using the output of the first inertial sensor.

In the robot according to the aspect of the invention, it is preferable that the first inertial sensor has a detection axis in an axis direction different from the axis direction of the nth rotation axis.

With this configuration, for example, in the case where an acceleration sensor is used as the first inertial sensor, the vibration of the nth arm about the nth rotation axis may be detected with higher accuracy using the output of the first inertial sensor. Accordingly, the vibrations of the robot may be efficiently reduced.

In the robot according to the aspect of the invention, it is preferable that the first inertial sensor is an acceleration sensor.

With this configuration, the vibration of the nth arm about the nth rotation axis may be detected with higher accuracy using the output of the first inertial sensor.

In the robot according to the aspect of the invention, it is preferable that the second inertial sensor has a detection axis in an axis direction parallel to the axis direction of the (n+1)th rotation axis.

With this configuration, for example, in the case where an angular velocity sensor is used as the second inertial sensor, the vibration of the (n+1)th arm about the (n+1)th rotation axis may be detected with higher accuracy using the output of the second inertial sensor. Accordingly, the vibrations of the robot may be efficiently reduced.

In the robot according to the aspect of the invention, it is preferable that the second inertial sensor has a detection axis in an axis direction different from the axis direction of the (n+1)th rotation axis.

With this configuration, for example, in the case where an acceleration sensor is used as the second inertial sensor, the vibration of the (n+1)th arm about the (n+1)th rotation axis may be detected with higher accuracy using the output of the second inertial sensor. Accordingly, the vibrations of the robot may be efficiently reduced.

In the robot according to the aspect of the invention, it is preferable that the first inertial sensor has a plurality of detection axes in axis directions different from one another.

With this configuration, the vibrations of the robot in the directions different from one another may be detected using the output of the first inertial sensor. Accordingly, the vibrations of the robot in a plurality of directions may be reduced based on the output of the first inertial sensor.

In the robot according to the aspect of the invention, it is preferable that the first inertial sensor is a triaxial angular velocity sensor.

With this configuration, even when the first inertial sensor is provided in the arm on the more distal end side than the nth arm, a vibration of the nth arm in a desired direction may be detected using the output of the first inertial sensor and the vibration of the nth arm in the desired direction may be reduced based on the output of the first inertial sensor. Further, regardless of an attitude in which the first inertial sensor is placed, a vibration in a desired direction in a location in which the sensor is placed may be detected. Accordingly, the degree of freedom of placement of the first inertial sensor increases.

In the robot according to the aspect of the invention, it is preferable that vibrations are reduced based on output of the first inertial sensor.

With this configuration, the robot with reduced vibrations may be provided.

A control apparatus according to an aspect of the invention controls actions of the robot according to the aspect of the invention.

According to the control apparatus, the actions of the robot that may reduce the space for preventing the interferences of the robot may be controlled. Further, the vibrations of the robot may be reduced.

A robot system according to an aspect of the invention includes the robot according to the aspect of the invention and a control apparatus controlling actions of the robot.

According to the robot system, the space for preventing the interferences of the robot may be reduced. Further, the vibrations of the robot may be reduced.

### BRIEF DESCRIPTION OF THE DRAWINGS

The invention will be described with reference to the accompanying drawings, wherein like numbers reference like elements.

FIG. 1 is a schematic configuration diagram showing a robot system according to the first embodiment of the invention.

FIG. 2 is a schematic diagram of a robot shown in FIG. 1.

FIG. 3 is a schematic side view of a state in which a first arm, a second arm, and a third arm of the robot shown in FIG. 1 do not overlap.

FIG. 4 is a schematic side view of a state in which the first arm, the second arm, and the third arm of the robot shown in FIG. 1 overlap.

FIG. 5 is a diagram for explanation of actions of the robot shown in FIG. 1.

FIG. 6 shows movement paths of a hand in the actions of the robot shown in FIG. 5.

FIG. 7 is a diagram for explanation of inertial sensors (angular velocity sensors) of the robot shown in FIG. 1.

FIG. 8 is a diagram for explanation of inertial sensors (angular velocity sensors) of a robot of a robot system according to the second embodiment of the invention.

FIG. 9 is a diagram for explanation of an inertial sensor (angular velocity sensor) of a robot of a robot system according to the third embodiment of the invention.

FIG. 10 is a diagram for explanation of inertial sensors (acceleration sensors) of a robot of a robot system according to the fourth embodiment of the invention.

### DESCRIPTION OF EXEMPLARY EMBODIMENTS

As below, a robot, a control apparatus, and a robot system according to the invention will be explained in detail based on preferred embodiments shown in the accompanying drawings.

### First Embodiment

### Robot System

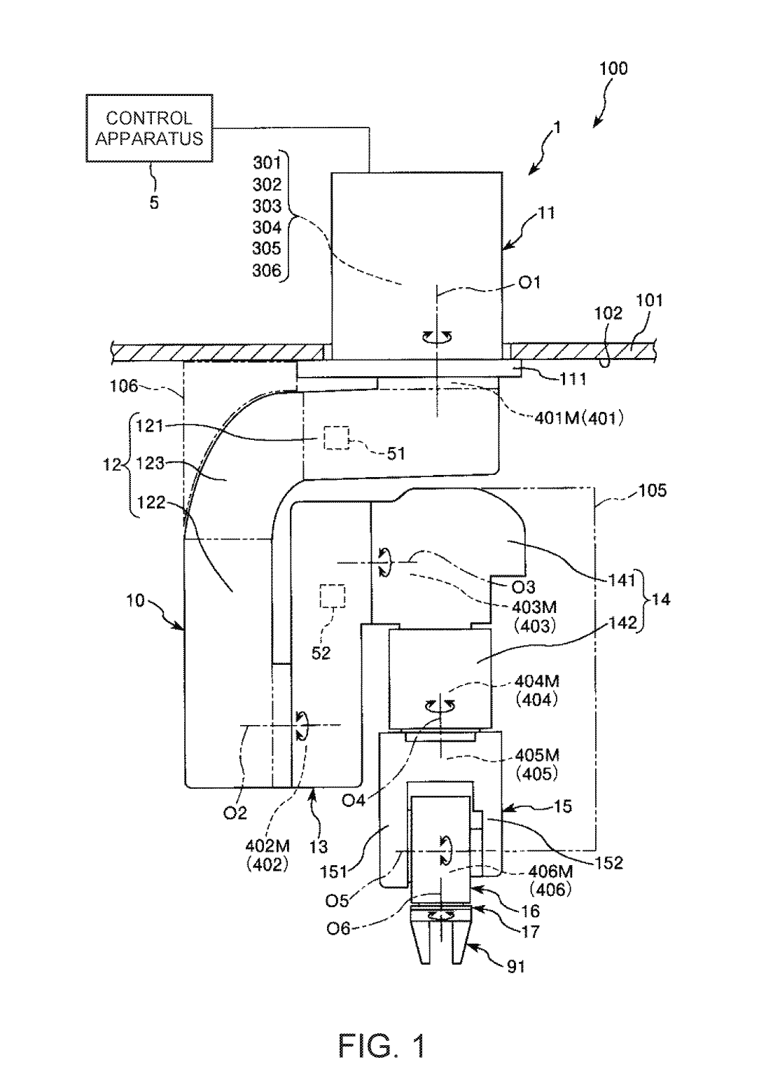

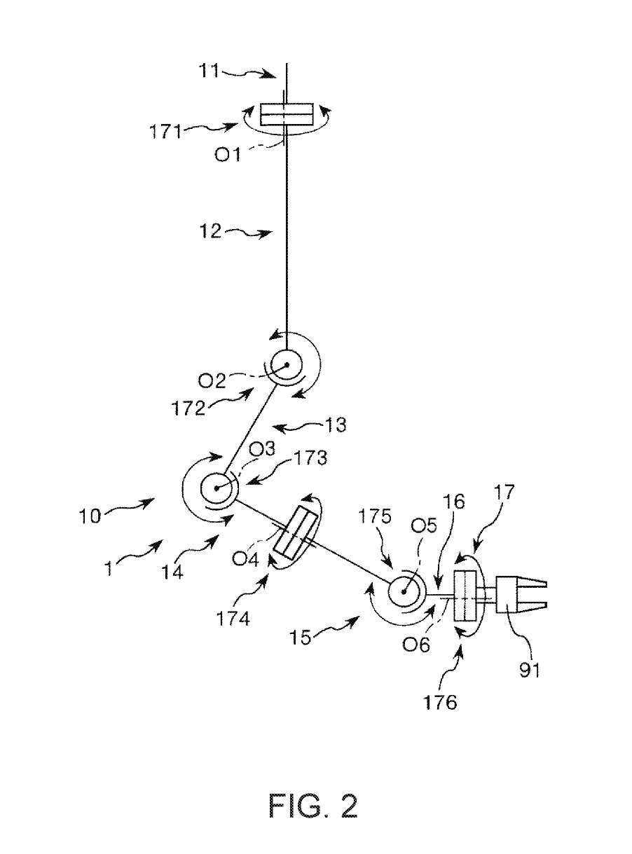

FIG. 1 is a schematic configuration diagram showing a robot system according to the first embodiment of the invention. FIG. 2 is a schematic diagram of a robot shown in FIG. 1.

Hereinafter, for convenience of explanation, the upside in FIG. 1 is referred to as “up” or “upper” and the downside is referred to as “low” or “lower”. Further, the base side in FIG. 1 is referred to as “proximal end” or “upstream” and the opposite side (the hand side) is referred to as “distal end” or “downstream”. Furthermore, upward and downward directions in FIG. 1 are referred to as “vertical directions” and rightward and leftward directions are referred to as “horizontal directions”. Note that, in the specification, the case where two axes “in parallel” with each other includes the case where one axis of the two axes is inclined within a range of 5° or less with respect to the other axis.

A robot system 100 shown in FIG. 1 includes a robot 1 and a control apparatus 5 that controls operation of the robot 1. The robot system 100 may be used in a manufacturing process of manufacturing precision apparatuses such as wristwatches or the like, for example.

### Robot

The robot 1 shown in FIG. 1 may perform work of feeding, removing, carrying, and assembly of the precision apparatuses and parts (objects) forming the apparatuses.

The robot 1 includes a base 11 and a robot arm 10. The robot arm 10 includes a first arm 12 (nth arm), a second arm 13 ((n+1)th arm), a third arm 14 ((n+2)th arm), a fourth arm 15, a fifth arm 16, and a sixth arm 17 (six arms). That is, the robot 1 is a vertical articulated (six-axis) robot in which the base 11, the first arm 12, the second arm 13, the third arm 14, the fourth arm 15, the fifth arm 16, and the sixth arm 17 are sequentially coupled from the proximal end side toward the distal end side. For example, an end effector such as a hand 91 that grasps a precision apparatus, a part, or the like may be detachably attached to the distal end of the sixth arm 17. Further, the robot 1 includes a first drive source 401, a second drive source 402, a third drive source 403, a fourth drive source 404, a fifth drive source 405, and a sixth drive source 406 (six drive sources). Furthermore, the robot 1 includes an inertial sensor 51 (first inertial sensor) and an inertial sensor 52 (second inertial sensor).

Hereinafter, the first arm 12, the second arm 13, the third arm 14, the fourth arm 15, the fifth arm 16, and the sixth arm 17 are respectively also referred to as “arm”. The first drive source 401, the second drive source 402, the third drive source 403, the fourth drive source 404, the fifth drive source 405, and the sixth drive source 406 are respectively also referred to as “drive source (drive unit)”.

### Base

As shown in FIG. 1, when the robot 1 is a suspended vertical articulated robot, the base 11 is a part located uppermost in the robot 1 and fixed (member attached) to e.g. an attachment surface 102 as a lower surface of a ceiling 101 as an installation space of the robot 1.

Note that, in the embodiment, a plate-like flange 111 provided in the lower part of the base 11 is attached to the attachment surface 102, however, the part fixed to the attachment surface 102 is not limited to that. For example, the part may be an upper surface of the base 11. The fixing method is not particularly limited, but e.g. a fixing method using a plurality of bolts or the like may be employed.

The location to which the base 11 is fixed is not limited to the ceiling of the installation space, but may be e.g. a wall, a floor, a ground of the installation space.

### Robot Arm

The robot arm 10 shown in FIG. 1 is rotatably supported with respect to the base 11 and the arms 12 to are respectively supported to be independently displaceable with respect to the base 11.

The first arm 12 has a bending shape. The first arm 12 has a first portion 121 provided on the base 11 and extending in the horizontal direction (a first direction), a second portion 122 provided on the second arm 13 and extending in the vertical direction (a second direction different from the first direction), a third portion 123 located between the first portion 121 and the second portion 122 and extending in a direction tilted with respect to the horizontal direction and the vertical direction (a direction different from the first direction and the second direction). More specifically, the first arm 12 has the first portion 121 connected to the base 11 and extending downward in the vertical direction from the base 11 and extending in the horizontal direction, the third portion 123 extending downward in the vertical direction while inclining from an opposite end of the first portion 121 to the connecting part to the base 11 in a direction farther from the first portion 121, and the second portion 122 extending downward in the vertical direction from the distal end of the third portion 123. These first portion 121, second portion 122, and third portion 123 are integrally formed. Further, the first portion 121 and the second portion 122 are nearly orthogonal (crossing) as seen from the near side of the paper surface of FIG. 1 (in a front view orthogonal to both a first rotation axis O1 and a second rotation axis O2, which will be described later).

The second arm 13 has a longitudinal shape and is connected to the distal end of the first arm 12 (the opposite end of the second portion 122 to the third portion 123).

The third arm 14 has a longitudinal shape and is connected to the opposite end of the second arm 13 to the end to which the first arm 12 is connected. The third arm is connected to the second arm 13, and has a first portion 141 extending from the second arm 13 in the horizontal direction and a second portion 142 extending from the first portion 141 in the vertical direction. These first portion 141 and second portion 142 are integrally formed. Further, the first portion 141 and the second portion 142 are nearly orthogonal (crossing) as seen from the near side of the paper surface of FIG. 1 (in a front view orthogonal to both a third rotation axis O3 and a fourth rotation axis O4, which will be described later).

The fourth arm 15 is connected to the opposite end of the third arm 14 to the end to which the second arm is connected. The fourth arm 15 has a pair of supporting portions 151, 152 opposed to each other. The supporting portions 151, 152 are used for connection to the fifth arm 16.

The fifth arm 16 is located between the supporting portions 151, 152 and connected to the supporting portions 151, 152, and thereby, coupled to the fourth arm 15. Note that the structure of the fourth arm is not limited to the structure, but may have one supporting portion (cantilever).

The sixth arm 17 has a flat plate shape and is connected to the distal end of the fifth arm 16. Further, the hand 91 is detachably attached to the distal end of the sixth arm 17 (the opposite end to the fifth arm 16). The hand 91 includes, but not particularly limited to, e.g. a configuration having a plurality of finger portions (fingers).

Each of the exteriors (the members forming the outer shapes) of the above described respective arms 12 to may be formed by a single member or a plurality of members.

Next, referring to FIG. 2, the drive sources 401 to 406 with driving of the arms 12 to 17 will be explained.

As shown in FIG. 2, the base 11 and the first arm 12 are coupled via a joint (connecting part) 171. The base 11 may include the joint 171 or not.

The joint 171 has a mechanism that rotatably supports the first arm 12 coupled to the base 11 with respect to the base 11. Thereby, the first arm 12 is rotatable around the first rotation axis O1 (nth rotation axis) in parallel to the vertical direction (about the first rotation axis O1) with respect to the base 11. The first rotation axis O1 is a rotation axis on the most upstream side of the robot 1. The rotation about the first rotation axis O1 is performed by driving of the first drive source 401 having a motor 401M. Further, the motor 401M of the first drive source 401 is electrically connected to a motor driver 301 via a cable (not shown) and controlled by a control unit (not shown) via the motor driver 301. Note that the first drive source 401 may be adapted to transmit the drive power from the motor 401M by a reducer (not shown) provided with the motor 401M, or the reducer may be omitted.

The first arm 12 and the second arm 13 are coupled via a joint (connecting part) 172. The joint 172 has a mechanism that rotatably supports one of the first arm 12 and the second arm 13 coupled to each other with respect to the other. Thereby, the second arm 13 is rotatable around the second rotation axis O2 ((n+1)th rotation axis) in parallel to the horizontal direction (about the second rotation axis O2) with respect to the first arm 12. The second rotation axis O2 is orthogonal to the first rotation axis O1. The rotation about the second rotation axis O2 is performed by driving of the second drive source 402 having a motor 402M. Further, the motor 402M of the second drive source 402 is electrically connected to a motor driver 302 via a cable (not shown) and controlled by a control unit (not shown) via the motor driver 302. Note that the second drive source 402 may be adapted to transmit the drive power from the motor 402M by a reducer (not shown) provided with the motor 402M, or the reducer may be omitted. The second rotation axis O2 may be parallel to an axis orthogonal to the first rotation axis O1, or the second rotation axis O2 may be different in axis direction from the first rotation axis O1, not orthogonal thereto.

The second arm 13 and the third arm 14 are coupled via a joint (connecting part) 173. The joint 173 has a mechanism that rotatably supports one of the second arm 13 and the third arm 14 coupled to each other with respect to the other. Thereby, the third arm 14 is rotatable around the third rotation axis O3 ((n+2)th rotation axis) in parallel to the horizontal direction (about the third rotation axis O3) with respect to the second arm 13. The third rotation axis O3 is parallel to the second rotation axis O2. The rotation about the third rotation axis O3 is performed by driving of the third drive source 403. Further, a motor 403M of the third drive source 403 is electrically connected to a motor driver 303 via a cable (not shown) and controlled by a control unit (not shown) via the motor driver 303. Note that the third drive source 403 may be adapted to transmit the drive power from the motor 403M by a reducer (not shown) provided with the motor 403M, or the reducer may be omitted.

The third arm 14 and the fourth arm 15 are coupled via a joint (connecting part) 174. The joint 174 has a mechanism that rotatably supports one of the third arm 14 and the fourth arm 15 coupled to each other with respect to the other. Thereby, the fourth arm 15 is rotatable around the fourth rotation axis O4 in parallel to the center axis direction of the third arm 14 (about the fourth rotation axis O4) with respect to the third arm 14. The fourth rotation axis O4 is orthogonal to the third rotation axis O3. The rotation about the fourth rotation axis O4 is performed by driving of the fourth drive source 404. Further, a motor 404M of the fourth drive source 404 is electrically connected to a motor driver 304 via a cable (not shown) and controlled by a control unit (not shown) via the motor driver 304. Note that the fourth drive source 404 may be adapted to transmit the drive power from the motor 404M by a reducer (not shown) provided with the motor 404M, or the reducer may be omitted. The fourth rotation axis O4 may be parallel to an axis orthogonal to the third rotation axis O3, or the fourth rotation axis O4 may be different in axis direction from the third rotation axis O3, not orthogonal thereto.

The fourth arm 15 and the fifth arm 16 are coupled via a joint (connecting part) 175. The joint 175 has a mechanism that rotatably supports one of the fourth arm 15 and the fifth arm 16 coupled to each other with respect to the other. Thereby, the fifth arm 16 is rotatable around a fifth rotation axis O5 orthogonal to the center axis direction of the fourth arm 15 (about the fifth rotation axis O5) with respect to the fourth arm 15. The fifth rotation axis O5 is orthogonal to the fourth rotation axis O4. The rotation about the fifth rotation axis O5 is performed by driving of the fifth drive source 405. Further, a motor 405M of the fifth drive source 405 is electrically connected to a motor driver 305 via a cable (not shown) and controlled by a control unit (not shown) via the motor driver 305. Note that the fifth drive source 405 may be adapted to transmit the drive power from the motor 405M by a reducer (not shown) provided with the motor 405M, or the reducer may be omitted. The fifth rotation axis O5 may be parallel to an axis orthogonal to the fourth rotation axis O4, or the fifth rotation axis O5 may be different in axis direction from the fourth rotation axis O4, not orthogonal thereto.

The fifth arm 16 and the sixth arm 17 are coupled via a joint (connecting part) 176. The joint 176 has a mechanism that rotatably supports one of the fifth arm 16 and the sixth arm 17 coupled to each other with respect to the other. Thereby, the sixth arm 17 is rotatable around a sixth rotation axis O6 (about the sixth rotation axis O6) with respect to the fifth arm 16. The sixth rotation axis O6 is orthogonal to the fifth rotation axis O5. The rotation about the sixth rotation axis O6 is performed by driving of the sixth drive source 406. Further, a motor 406M of the sixth drive source 406 is electrically connected to a motor driver 306 via a cable (not shown) and controlled by a control unit (not shown) via the motor driver 306. Note that the sixth drive source 406 may be adapted to transmit the drive power from the motor 406M by a reducer (not shown) provided with the motor 406M, or the reducer may be omitted. The sixth rotation axis O6 may be parallel to an axis orthogonal to the fourth rotation axis O4, the sixth rotation axis O6 may be parallel to an axis orthogonal to the fifth rotation axis O5, or the sixth rotation axis O6 may be different in axis direction from the fifth rotation axis O5, not orthogonal thereto.

The robot 1 driving in the above described manner controls the actions of the respective arms 12 to 17 etc. while grasping a precision apparatus, a part, or the like with the hand 91 connected to the distal end of the sixth arm 17, and thereby, may perform respective works of carrying the precision apparatus, the part, etc. The driving of the hand 91 is controlled by the control apparatus 5.

### Inertial Sensors

The inertial sensors 51, 52 shown in FIG. 1 are respectively angular velocity sensors (gyro sensors). In the embodiment, the inertial sensor 51 (first inertial sensor) is provided in the first portion 121 of the first arm 12 and has a function of detecting actions of the arm including the vibration of the first arm 12. The inertial sensor 52 (second inertial sensor) is provided in the second arm 13 and has a function of detecting actions of the arm including the vibration of the second arm 13. These inertial sensors 51, 52 respectively output signals according to the detected actions of the arms. The inertial sensors 51, 52 are not particularly limited as long as the sensors may respectively detect angular velocities. For example, vibration angular velocity sensors having vibrator elements formed using silicon or quartz crystal may be used.

According to the control apparatus 5, the actions of the robot 1 may be controlled. Particularly, the control apparatus 5 may reduce vibrations of the robot 1 based on the output of the inertial sensors 51, 52. The inertial sensors 51, 52 will be described later in detail.

### Control Apparatus

The control apparatus 5 shown in FIG. 1 has a function of controlling the actions of the robot 1. Particularly, the control apparatus 5 has a function of reducing vibrations of the robot 1 based on the output of the inertial sensors 51, 52. The reduction of the vibrations of the robot will be described later in detail with the description of the inertial sensors 51, 52.

The control apparatus 5 may be formed using e.g. a personal computer (PC) containing a CPU (Central Processing Unit) or the like. In the embodiment, the control apparatus 5 is provided separately from the robot 1, however, may be built in the robot 1.

As above, the basic configuration of the robot 1 is briefly explained. The robot 1 having the configuration is the vertical articulated robot having the six (plurality of) arms 12 to 17 as described above, and thereby, the drive range is wider and higher workability may be exerted.

Further, as described above, in the robot 1, the proximal end side of the first arm 12 is attached to the base 11, and thereby, the respective arms 12 to 17 may be rotated with respect to the base 11. Furthermore, the robot 1 is of the suspended type with the base 11 attached to the ceiling 101, and the joint 171 as the connecting part between the base 11 and the first arm 12 is located above the joint 172 as the connecting part between the first arm 12 and the second arm 13 in the vertical direction. Accordingly, the work range of the robot 1 below the robot 1 in the vertical direction may be made wider.

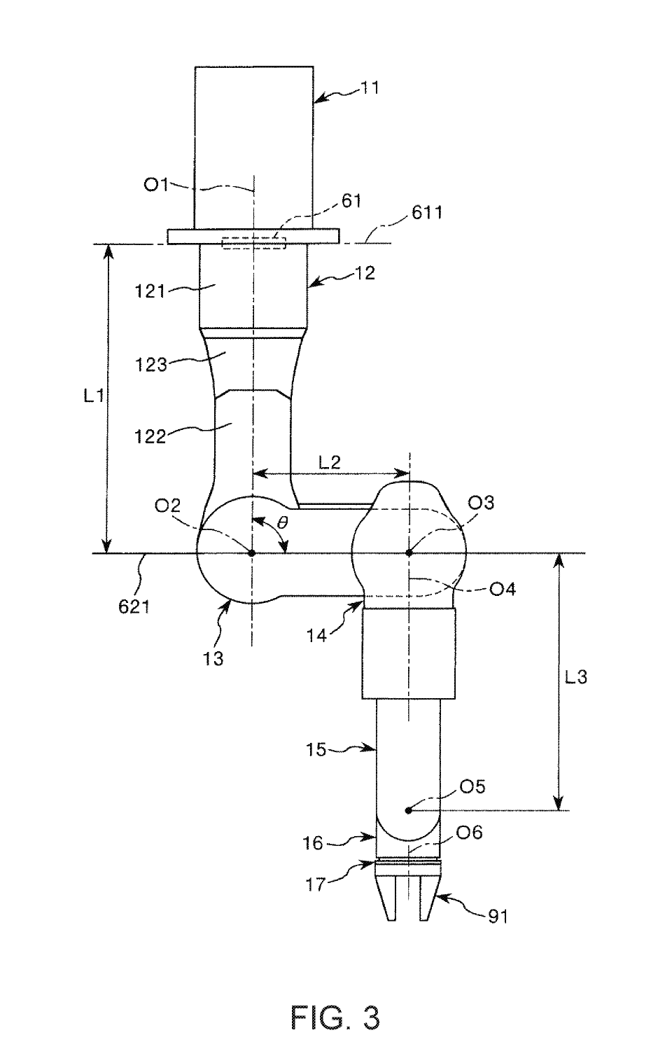

Next, referring to FIGS. 3, 4, 5, and 6, the relationships among the respective arms 12 to 17 will be explained.

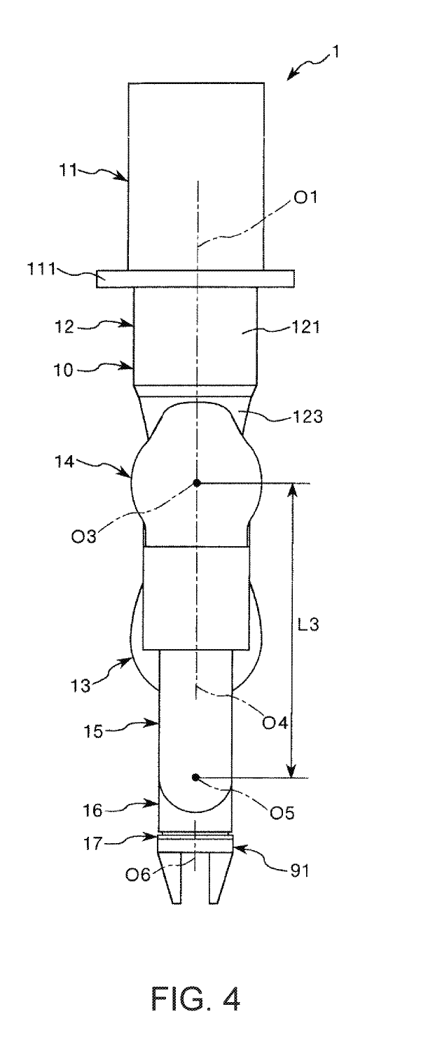

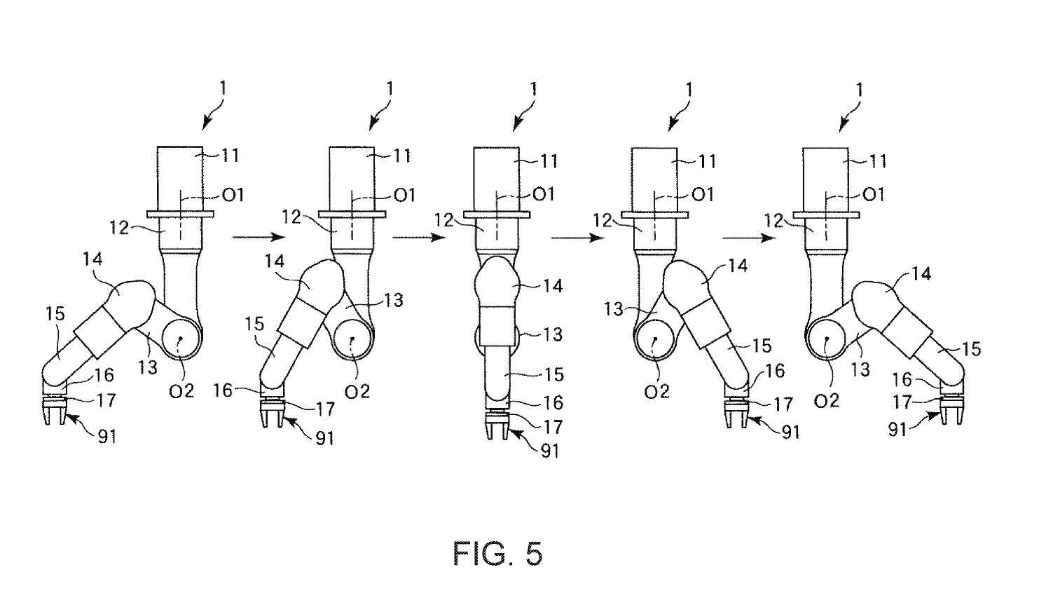

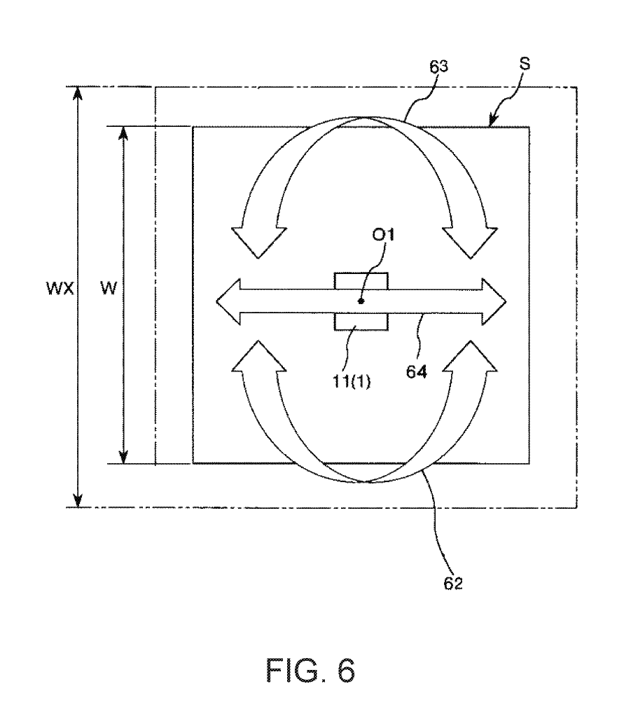

FIG. 3 is a schematic side view of a state in which the first arm, the second arm, and the third arm of the robot shown in FIG. 1 do not overlap. FIG. 4 is a schematic side view of a state in which the first arm, the second arm, and the third arm of the robot shown in FIG. 1 overlap. FIG. 5 is a diagram for explanation of actions of the robot shown in FIG. 1. FIG. 6 shows movement paths of the hand in the actions of the robot shown in FIG. 5.

In the following explanation, the third arm 14, the fourth arm 15, the fifth arm 16, and the sixth arm 17 are considered in a condition that the arms are stretched straight, in other words, in a condition that the fourth rotation axis O4 and the sixth rotation axis O6 are aligned or in parallel as shown in FIGS. 3 and 4.

First, as shown in FIG. 3, a length L1 of the first arm 12 is set to be longer than a length L2 of the second arm 13.

Here, the length L1 of the first arm 12 is a distance between the second rotation axis O2 and the attachment surface 102 (see FIG. 1) as seen from the axis direction of the second rotation axis O2. Further, the length L2 of the second arm 13 is a distance between the second rotation axis O2 and the third rotation axis O3 as seen from the axis direction of the second rotation axis O2. Note that the length L1 of the first arm 12 may be regarded as a distance between the second rotation axis O2 and a center line 611 extending in the leftward and rightward directions in FIG. 3 of a bearing part 61 (a member of the joint 171) that rotatably supports the first arm 12 as seen from the axis direction of the second rotation axis O2. Or, the length L1 of the first arm 12 may be regarded as a distance between the distal end surface of first arm 12 and the attachment surface 102 as seen from the axis direction of the second rotation axis O2 and the length L2 of the second arm 13 may be regarded as a distance between the distal end surface of the second arm 13 and the proximal end surface of the second arm 13 as seen from the axis direction of the second rotation axis O2.

Further, as shown in FIGS. 3 and 4, the robot 1 is adapted so that an angle θ formed between the first arm 12 and the second arm 13 can be 0° as seen from the axis direction of the second rotation axis O2. That is, the robot 1 is adapted so that the first arm 12 and the second arm 13 can overlap as seen from the axis direction of the second rotation axis O2. Particularly, as described above, the length L1 of the first arm 12 is set to be longer than the length L2 of the second arm 13, and the second arm 13 is adapted not to interfere with the first arm 12, when the first arm 12 and the second arm 13 overlap as seen from the axis direction of the second rotation axis O2.

Here, the angle θ formed by the first arm 12 and the second arm 13 is an angle formed by a straight line passing through the second rotation axis O2 and the third rotation axis O3 (a center axis of the second arm 13 as seen from the axis direction of the second rotation axis O2) 621 and the first rotation axis O1 as seen from the axis direction of the second rotation axis O2 (see FIG. 3).

Furthermore, as shown in FIG. 4, the robot 1 is adapted so that the second arm 13 and the third arm 14 can overlap as seen from the axis direction of the second rotation axis O2. Therefore, the robot 1 is adapted so that the first arm 12, the second arm 13, and the third arm 14 can overlap at the same time as seen from the axis direction of the second rotation axis O2.

As shown in FIG. 3, a total length L3 of the third arm 14, the fourth arm 15, and the fifth arm 16 is set to be longer than the length L2 of the second arm 13. Thereby, as shown in FIG. 4, as seen from the axis direction of the second rotation axis O2, when the second arm 13 and the third arm 14 are overlapped, the distal end of the robot arm 10, i.e., the distal end of the sixth arm 17 may be protruded from the second arm 13. Therefore, the hand 91 may be prevented from interfering with the first arm 12 and the second arm 13.

Here, the total length L3 of the third arm 14, the fourth arm 15, and the fifth arm 16 is a distance between the third rotation axis O3 and the fifth rotation axis O5 as seen from the axis direction of the second rotation axis O2 (see FIG. 4). In this case, regarding the third arm 14, the fourth arm 15, and the fifth arm 16, the fourth rotation axis O4 and the sixth rotation axis O6 are aligned or in parallel as shown in FIG. 4.

In the robot 1 having the robot arm 10, the above described relationships are satisfied, and thereby, as shown in FIG. 5, by rotation of the second arm 13 and the third arm 14 without rotation of the first arm 12, the hand 91 (the distal end of the third arm 14) may be moved to a position different by 180° about the first rotation axis O1 through the state in which the angle θ formed by the first arm 12 and the third arm 13 is 0° (the first arm 12 and the second arm 13 overlap) as seen from the axis direction of the second rotation axis O2.

By the driving of the robot arm 10, as shown in FIG. 6, the robot 1 may perform an action of moving the hand 91 as shown by an arrow 64 without actions of moving the hand 91 as shown by arrows 62, 63. That is, the robot 1 may perform the action of moving the hand 91 (the distal end of the robot arm 10) linearly as seen from the axis direction of the first rotation axis O1. Thereby, the space for preventing interferences of the robot 1 may be made smaller. Accordingly, the area S of the installation space for installation of the robot 1 (installation area) may be made smaller than that of related art.

Specifically, as shown in FIG. 6, the width W of the installation space of the robot 1 may be made smaller than a width WX of the installation space of related art, e.g. 80% of the width WX or less. Accordingly, the operation region of the robot 1 in the width direction (the direction of the production line) may be made smaller. Thereby, the larger number of robots 1 may be arranged along the production line per unit length and the production line may be shortened.

Further, similarly, the height of the installation space of the robot 1 (the length in the vertical direction) may be made lower than the height of related art, specifically, e.g. 80% of the height of related art or less.

The action of moving the hand 91 as shown by the arrow 64 can be performed, and, when the hand 91 is moved to a position different by 180° about the first rotation axis O1, for example, it may be possible that the first arm 12 is not rotated or the rotation angle (amount of rotation) of the first arm 12 is made smaller. The rotation angle of the first arm 12 about the first rotation axis O1 is made smaller, and thereby, the rotation of the first arm 12 having portions protruding outward than the base 11 (the second portion 122 and the third portion 123) may be made smaller as seen from the axis direction of the first rotation axis O1, and interferences of the robot 1 with peripherals may be reduced.

Further, the action of moving the hand 91 as shown by the arrow 64 can be performed and the movement of the robot 1 may be reduced, and thereby, the robot 1 may be efficiently driven. Accordingly, the takt time may be shortened and the work efficiency may be improved. Furthermore, the distal end of the robot arm 10 may be linearly moved and the movement of the robot 1 may be easily grasped.

Here, to execute the above described action of moving the hand 91 of the robot 1 (the distal end of the robot arm 10) to a position different by 180° about the first rotation axis O1 by simply rotating the first arm 12 about the first rotation axis O1 like the robot of related art, the robot 1 may interfere with the peripherals, and thus, it is necessary to teach the robot 1 an evacuation point for avoiding the interference. For example, in the case where, when only the first arm 12 is rotated to 90° about the first rotation axis O1, the robot 1 also interferes with the peripherals, it is necessary to teach the robot 1 many evacuation points to prevent interferences with the peripherals. As described above, in the robot of related art, it is necessary to teach many evacuation points, an enormous number of evacuation points are necessary, and a lot of effort and time are taken for teaching.

On the other hand, in the robot 1, when the action of moving the hand 91 to a position different by 180° about the first rotation axis O1 is executed, the number of regions and portions that may interfere is very small and the number of evacuation points to teach may be reduced and effort and time taken for teaching may be reduced. That is, in the robot 1, the number of evacuation points to teach may be about ⅓ of that of the robot of related art, and teaching is dramatically easier.

In the robot 1, a region (part) 105 of the third arm 14 and the fourth arm 15 surrounded by a dashed-two dotted line on the right in FIG. 1 is a region (part) in which the robot 1 does not or is hard to interfere with the robot 1 itself or the other members. Accordingly, when a predetermined member is mounted on the region 105, the member is hard to interfere with the robot 1 and peripherals or the like. Therefore, in the robot 1, a predetermined member may be mounted on the region 105. Particularly, the case where the predetermined member is mounted on a region of the third arm 14 on the right in FIG. 1 of the region 105 is more effective because the probability that the member interferes with peripherals (not shown) is lower.

Objects that can be mounted on the region 105 include e.g. a controller for controlling driving of a sensor of a hand, a hand eye camera, or the like, a solenoid valve for a suction mechanism, etc.

As a specific example, for example, when a suction mechanism is provided on the hand, if a solenoid valve or the like is provided in the region 105, the solenoid valve causes no obstruction when the robot 1 is driven. The region 105 is highly convenient as described above.

Further, in the robot 1, also, a region (part) 106 surrounded by a dashed-two dotted line on the left in FIG. 1 is a region (part) in which the robot 1 does not or is hard to interfere with the robot 1 itself or the other members like the above described region 105.

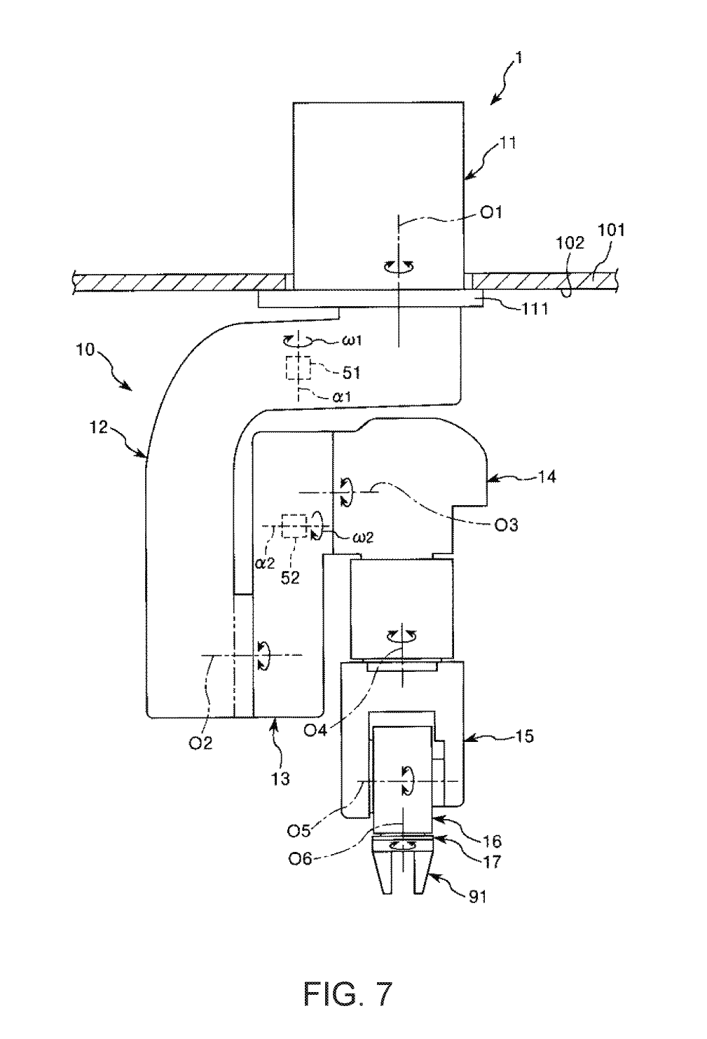

Next, control using the inertial sensors 51, 52 and their detection results (control for reducing vibrations of the robot 1) will be described in detail with reference to FIG. 7.

FIG. 7 is a diagram for explanation of the inertial sensors (angular velocity sensors) of the robot shown in FIG. 1.

As described above, the robot 1 includes the inertial sensor 51 (first inertial sensor) provided in the first arm 12 and the inertial sensor 52 (second inertial sensor) provided in the second arm 13.

As shown in FIG. 7, the inertial sensor 51 is a uniaxial angular velocity sensor that detects an angular velocity ω1 about a detection axis α1. The inertial sensor 51 is placed so that the detection axis α1 may be parallel to the first rotation axis O1. In the embodiment, the inertial sensor 51 is provided in the portion of the first arm 12 on the proximal end side (first portion 121).

Note that, here, “the detection axis α1 parallel to the first rotation axis O1” includes the case where the detection axis α1 is inclined within a range of 5° or less with respect to the first rotation axis O1. The position in which the inertial sensor 51 is placed shown in FIG. 7 is an example, and is not limited to the illustrated position, but may be any position of the first arm 12 as long as the sensor may detect the vibration of the first arm 12 about the first rotation axis O1. Further, the detection axis α1 may be aligned with the first rotation axis O1. Furthermore, the detection axis α1 may be inclined with respect to the first rotation axis O1, however, in this case, it is preferable that the inclination angle is as small as possible for efficient detection of the vibration of the first arm 12 about the first rotation axis O1. Specifically, the angle is preferably 45° or less and more preferably 10° or less.

The inertial sensor 52 is a uniaxial angular velocity sensor that detects an angular velocity w2 about a detection axis α2. The inertial sensor 52 is placed so that the detection axis α2 may be parallel to the second rotation axis O2. In the embodiment, the inertial sensor 52 is provided in the portion of the second arm 13 between the second rotation axis O2 and the third rotation axis O3.

Note that, here, “the detection axis α2 parallel to the second rotation axis O2” includes the case where the detection axis α2 is inclined within a range of 5° or less with respect to the second rotation axis O2. The position in which the inertial sensor 52 is placed shown in FIG. 7 is an example, and is not limited to the illustrated position, but may be any position of the second arm 13 as long as the sensor may detect the vibration of the second arm 13 about the second rotation axis O2. Further, the detection axis α2 may be aligned with the second rotation axis O2. Furthermore, the detection axis α2 may be inclined with respect to the second rotation axis O2, however, in this case, it is preferable that the inclination angle is as small as possible for efficient detection of the vibration of the second arm 13 about the second rotation axis O2. Specifically, the angle is preferably 45° or less and more preferably 10° or less.

The above described inertial sensors 51, 52 are electrically connected to the control apparatus 5 shown in FIG. 1. Further, the output of the inertial sensors 51, 52 is input to the control apparatus 5.

The control apparatus 5 performs control of reducing the vibrations of the robot 1 based on the output of the inertial sensors 51, 52. More specifically, the control apparatus 5 controls driving of the motor 401M to reduce the vibration of the first arm 12 about the first rotation axis O1 based on the output of the inertial sensor 51. Further, the control apparatus 5 controls driving of the motor 402M to reduce the vibration of the second arm 13 about the second rotation axis O2 based on the output of the inertial sensor 52.

Generally, the vibration on the distal end side of the robot arm 10 is more readily affected by the vibrations of the arms on the more proximal end side about the rotation axes. Particularly, like the robot 1 of the embodiment, in the configuration in which the number of arms of the robot arm 10 is relatively large and the length of the robot arm 10 is relatively long, and the arms on the more distal end side than the first arm 12 are cantilevered with respect to the first arm 12, the vibration on the proximal end side of the robot arm 10 largely affects the vibration on the distal end side. Accordingly, to reduce the vibration of the distal end of the robot arm 10, preferential reduction of the vibrations of the arms on the more distal end side is effective. Therefore, in the embodiment, as described above, of the plurality of arms of the robot arm 10, the inertial sensor 51 is provided in the first arm 12 and the inertial sensor 52 is provided in the second arm 13.

The inertial sensor 51 is provided in the first arm, and thereby, the vibration of the first arm 12 may be detected with higher accuracy using the output of the inertial sensor 51. Accordingly, the vibration of the first arm 12 may be reduced by relatively simple control based on the output of the inertial sensor 51. Similarly, the inertial sensor 52 is provided in the second arm 13, and thereby, the vibration of the second arm 13 may be detected with high accuracy using the output of the inertial sensor 52. Accordingly, the vibration of the second arm 13 may be reduced by relatively easy control based on the output of the inertial sensor 52.

Further, the axis direction of the detection axis α1 of the inertial sensor 51 as the angular velocity sensor is parallel to the axis direction of the first rotation axis O1, and thereby, the vibration of the first arm 12 about the first rotation axis O1 may be detected with higher accuracy using the output of the inertial sensor 51. Accordingly, the vibrations of the robot 1 may be efficiently reduced. For example, when the vibration of the first arm 12 is reduced based on the output of the inertial sensor 51, the calculation amount necessary for the control of the operation of the motor 401M in the control apparatus 5 may be reduced. In comparison to the case where a triaxial angular velocity sensor is used, the cost may be reduced and the weight of the first arm 12 may be reduced.

Similarly, the axis direction of the detection axis α2 of the inertial sensor 52 as the angular velocity sensor is parallel to the axis direction of the second rotation axis O2, and thereby, the vibration of the second arm 13 about the second rotation axis O2 may be detected with higher accuracy using the output of the inertial sensor 52.

According to the above described robot system 100, the space for preventing interferences of the robot 1 may be made smaller. Further, the vibrations of the robot 1 may be reduced.

### Second Embodiment

Next, the second embodiment of the invention will be explained.

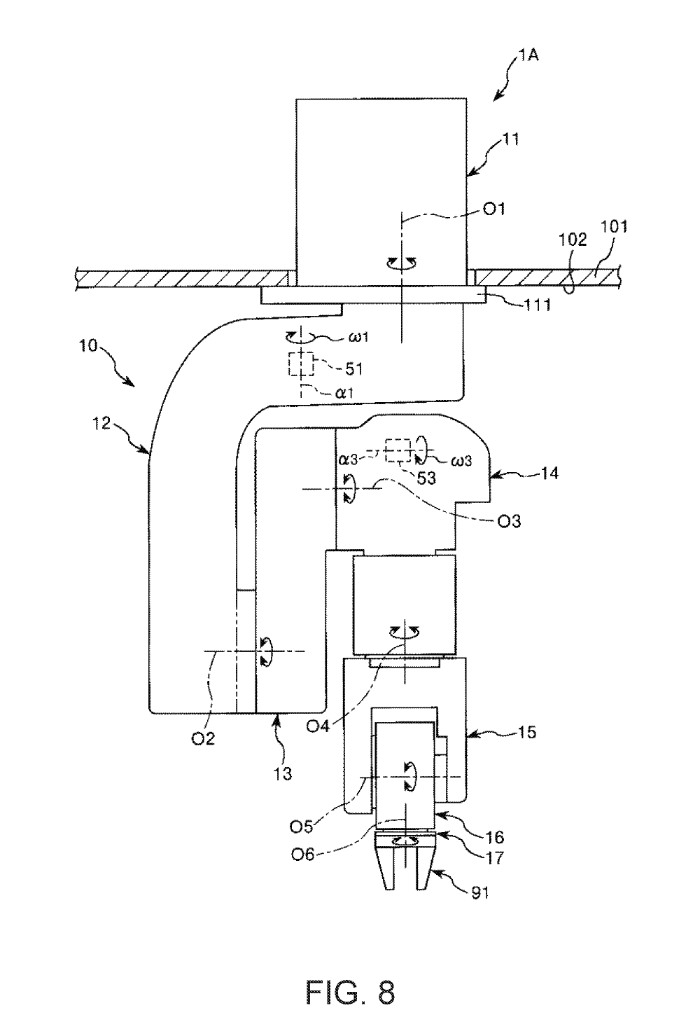

FIG. 8 is a diagram for explanation of inertial sensors (angular velocity sensors) of a robot of a robot system according to the second embodiment of the invention.

As below, the second embodiment will be explained with a focus on differences from the above described embodiment and the explanation of the same items will be omitted.

A robot 1A shown in FIG. 8 is the same as the above described robot 1 except that an inertial sensor 53 (second inertial sensor) is provided in place of the inertial sensor 52 of the above described robot 1 of the first embodiment.

The inertial sensor 53 is a uniaxial angular velocity sensor provided in the third arm 14 and detecting an angular velocity ω3 about a detection axis α3. The inertial sensor 53 is placed so that the detection axis α3 may be parallel to the third rotation axis O3.

Note that, here, “the detection axis α3 parallel to the third rotation axis O3” includes the case where the detection axis α3 is inclined within a range of 5° or less with respect to the third rotation axis O3. The position in which the inertial sensor 53 is placed shown in FIG. 8 is an example, and is not limited to the illustrated position, but may be any position of the third arm 14 as long as the sensor may detect the vibration of the third arm 14 about the third rotation axis O3. For example, the detection axis α3 may be aligned with the third rotation axis O3. Or, the detection axis α3 may be inclined with respect to the third rotation axis O3, however, in this case, it is preferable that the inclination angle is as small as possible for efficient detection of the vibration of the third arm 14 about the third rotation axis O3. Specifically, the angle is preferably 45° or less and more preferably 10° or less.

The inertial sensor 53 is provided in the third arm 14, and thereby, vibrations of both the second arm 13 and the third arm 14 may be reduced based on the output of the inertial sensor 53.

According to the above described second embodiment, the space for preventing interferences of the robot 1A may be made smaller, and the vibrations of the robot 1A may be reduced.

### Third Embodiment

Next, the third embodiment of the invention will be explained.

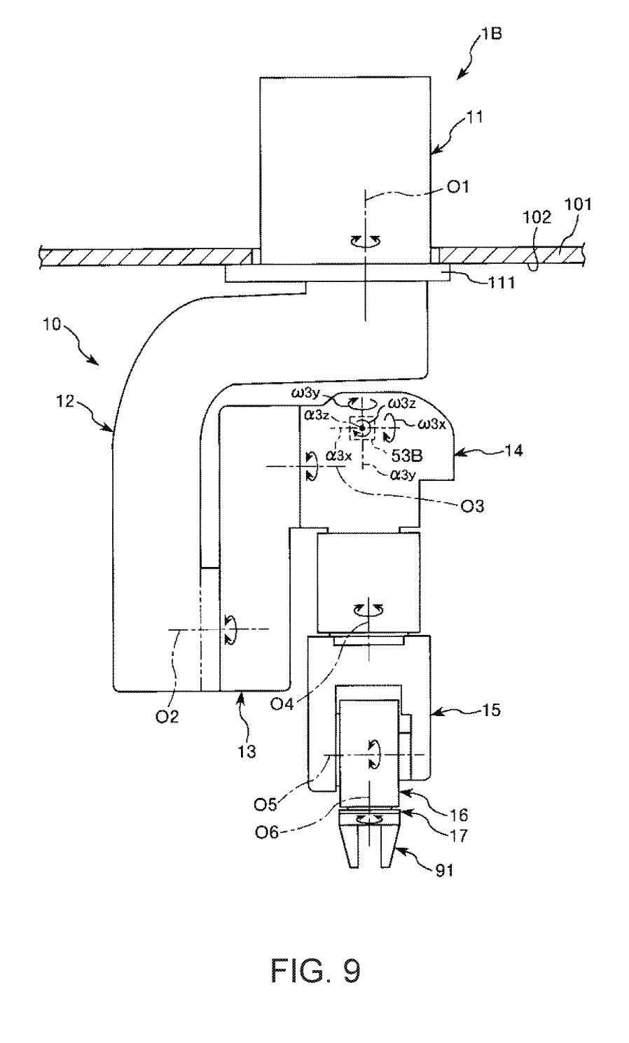

FIG. 9 is a diagram for explanation of an inertial sensor (angular velocity sensor) of a robot of a robot system according to the third embodiment of the invention.

As below, the third embodiment of the invention will be explained with a focus on differences from the above described embodiments and the explanation of the same items will be omitted.

A robot 1B shown in FIG. 9 is the same as the above described robot 1 except that an inertial sensor 53B (first inertial sensor) is provided in place of the inertial sensors 51, 52 of the above described robot 1 of the first embodiment.

The inertial sensor 53B is a triaxial angular velocity sensor provided in the third arm 14 and detecting angular velocities ω3x, ω3y, ω3z about detection axes α3x, α3y, α3z orthogonal to one another. The inertial sensor 53B is placed so that the detection axis α3x may be parallel to the third rotation axis O3. The inertial sensor 53B may be formed by integration of three uniaxial angular velocity sensors for detecting the angular velocities ω3x, ω3y, ω3z about the detection axes α3x, α3y, α3z or formed for detecting the angular velocities ω3x, ω3y, ω3z about the detection axes α3x, α3y, α3z with a single vibrator element.

Note that the position in which the inertial sensor 53 is placed shown in FIG. 9 is an example, and is not limited to the illustrated position, but may be any position of the third arm 14. The placement attitude of the inertial sensor 53B is not limited to the above described one. Further, the detection axis α3x may be aligned with the third rotation axis O3. Or, the detection axis α3x may be inclined with respect to the third rotation axis O3, however, in this case, when the robot 1 is controlled using the output of the inertial sensor 53B, calculation in consideration of the inclination may be performed.

To reduce vibrations of the robot 1B using output of the inertial sensor 53B, driving of the motors 401M, 402M, 403M is controlled to reduce the vibration of the first arm 12 about the first rotation axis O1, the vibration of the second arm 13 about the second rotation axis O2, and the vibration of the third arm 14 about the third rotation axis O3, respectively. In this regard, rotation angle information of rotary encoders (not shown) provided in the drive sources 401, 402, 403 may be used as appropriate.

The inertial sensor 53B is provided in the third arm 14, and thereby, vibrations of the second arm 13 and the third arm 14 may be reduced based on the output of the inertial sensor 53B.

Particularly, in the embodiment, the inertial sensor 53B has the plurality of detection axes α3x, α3y, α3z in axis directions different from one another, and thereby, the vibrations in the different directions from one another may be detected using the output of the inertial sensor 53B. Accordingly, the vibrations of the robot 1B in the plurality of directions may be reduced based on the output of the inertial sensor 53B.

In addition, even when the inertial sensor 53B is provided in the third arm 14 on the more distal end side than the first arm 12 and the second arm 13, vibrations not only of the third arm 14 but also of the first arm 12 and the second arm 13 in desired directions may be detected using the output of the inertial sensor 53B and a vibration of the first arm 12 in a desired direction may be reduced based on the output of the inertial sensor 53B. Therefore, only one inertial sensor is necessary for detection of the vibrations of the first arm 12, the second arm 13, and the third arm 14, and wiring for the inertial sensor may be simplified and the whole robot arm 10 may be downsized. Further, regardless of the placement attitude of the inertial sensor 53B, vibrations in desired directions in the placement location may be detected. Accordingly, the degree of freedom of placement of the inertial sensor 53B increases.

According to the above described third embodiment, the space for preventing interferences of the robot 1B may be made smaller, and the vibrations of the robot 1B may be reduced.

### Fourth Embodiment

Next, the fourth embodiment of the invention will be explained.

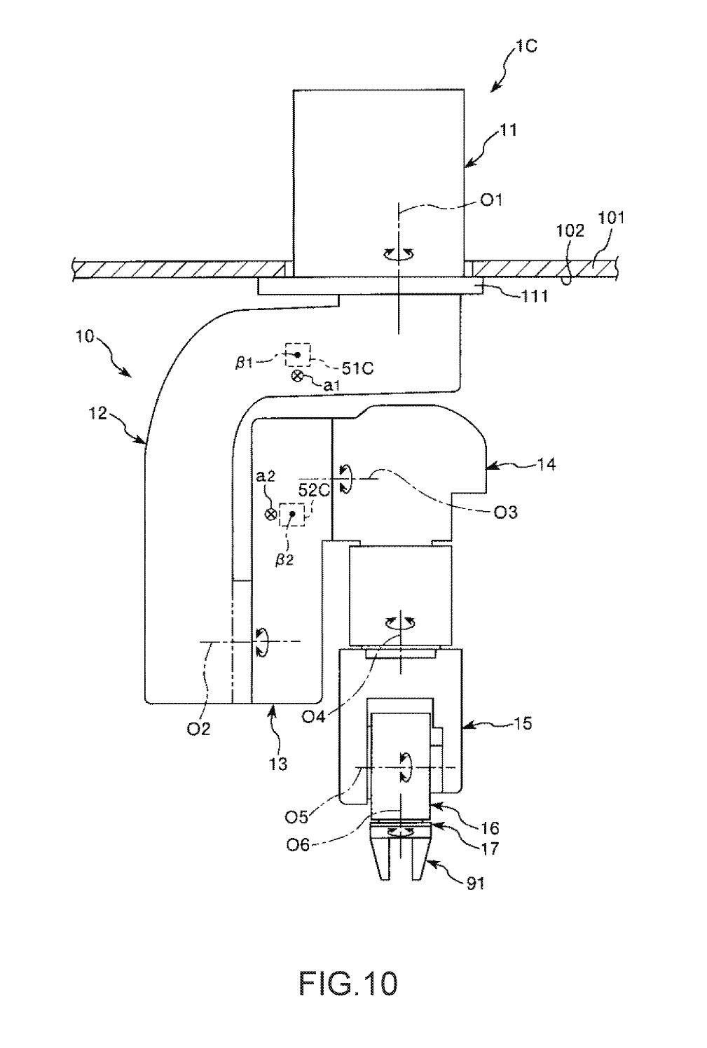

FIG. 10 is a diagram for explanation of inertial sensors (acceleration sensors) of a robot of a robot system according to the fourth embodiment of the invention.

As below, the fourth embodiment of the invention will be explained with a focus on differences from the above described embodiments and the explanation of the same items will be omitted.

A robot 1C shown in FIG. 10 is the same as the above described robot 1 except that inertial sensors 51C, 52C are provided in place of the inertial sensors 51, 52 of the above described robot 1 of the first embodiment.

As shown in FIG. 10, the inertial sensor 51C is a uniaxial acceleration sensor that detects an acceleration a1 in a direction parallel to a detection axis β1. The inertial sensor 51C is placed so that the detection axis β1 may be in a direction different from that of the first rotation axis O1. The axis direction of the detection axis β1 of the inertial sensor 51C is different from the axis direction of the first rotation axis O1, and thereby, the vibration of the first arm 12 about the first rotation axis O1 may be detected with higher accuracy using output of the inertial sensor 51C.

Further, the inertial sensor 52C is a uniaxial acceleration sensor that detects an acceleration a2 in a direction parallel to a detection axis β2. The inertial sensor 52C is placed so that the detection axis β2 may be in a direction different from that of the second rotation axis O2. The axis direction of the detection axis β2 of the inertial sensor 52C is different from the axis direction of the second rotation axis O2, and thereby, the vibration of the second arm 13 about the second rotation axis O2 may be detected with higher accuracy using output of the inertial sensor 52C.

The inertial sensors 51C, 52C are not particularly limited as long as the sensors may respectively detect accelerations. For example, acceleration sensors including acceleration sensor devices manufactured using the MEMS technology may be used. Or, the inertial sensors 51C, 52C may be acceleration sensors having pluralities of detection axes.

The placement position of the inertial sensor 51C shown in FIG. 10 is an example, and is not limited to the illustrated position, but may be any position as long as the sensor may detect the vibration of the first arm 12 about the first rotation axis O1. Further, the placement attitude of the inertial sensor 51C shown in FIG. 10 (the orientation of the detection axis β1) is for descriptive purpose and not limited to the illustrated attitude as long as the sensor may detect the vibration of the first arm 12 about the first rotation axis O1. Similarly, the placement position and the placement attitude of the inertial sensor 52C are not limited to those illustrated.

According to the above described fourth embodiment, the space for preventing interferences of the robot 1C may be made smaller, and the vibrations of the robot 1C may be reduced.

As above, the robot, the control apparatus, and the robot system according to the invention are explained according to the illustrated embodiments, however, the invention is not limited to those and the configurations of the respective parts may be replaced by arbitrary configurations having the same functions. Further, other arbitrary configurations may be added. Furthermore, the invention may include a combination of two or more arbitrary configurations (features) of the above described respective embodiments.

In the above described embodiments, the number of rotation axes of the robot arm of the robot is six, however, the invention is not limited to that. The number of rotation axes of the robot arm may be e.g. two, three, four, five, or seven or more. Further, in the above described embodiments, the number of arms of the robot is six, however, the invention is not limited to that. The number of arms of the robot may be e.g. two, three, four, five, or seven or more.

Furthermore, in the above described embodiments, the number of robot arms of the robot is one, however, the invention is not limited to that. The number of robot arms of the robot may be e.g. two or more. That is, the robot may be e.g. a multi-arm robot including a dual-arm robot.

In the above described embodiments, the case where either the angular velocity sensors or the acceleration sensors are provided in the arms as the inertial sensors is explained as the example, however, a combination of the angular velocity sensor and the acceleration sensor may be provided in the arm. For example, as at least one of the first inertial sensor and the second inertial sensor, a combination of an angular velocity sensor having three detection axes and an angular velocity sensor having three detection axes (so-called six-axis inertial sensor) may be used.

Further, in the above described embodiments, the case where the first inertial sensor or the second inertial sensor is provided in the first arm, the second arm, or the third arm is explained as the example, however, the placement position of the inertial sensor may be in any part of the robot arm, e.g. the fourth arm, the fifth arm, the sixth arm, or the distal end part like the end effector.

The entire disclosure of Japanese Patent Application No. 2015-215650, filed Nov. 2, 2015 is expressly incorporated by reference herein.

What is claimed is:

1. A robot comprising:
an nth (n is an integer equal to or more than one) arm rotatable about an nth rotation axis; and
an (n+1)th arm provided on the nth arm to be rotatable about an (n+1)th rotation axis in a axis direction different from a axis direction of the nth rotation axis; and
a first inertial sensor,
wherein the nth arm and the (n+1)th arm can overlap as seen from the axis direction of the (n+1)th rotation axis.

2. The robot according to claim 1, wherein a length of the nth arm is longer than a length of the (n+1)th arm.

3. The robot according to claim 1, further comprising a base,
wherein the nth (n is one) arm is provided on the base to be rotatable about the nth rotation axis.

4. The robot according to claim 3, wherein the first inertial sensor is provided in the nth arm.

5. The robot according to claim 4, further comprising a second inertial sensor provided in the (n+1)th arm.

6. The robot according to claim 4, further comprising:
an (n+2)th arm provided on the (n+1)th arm to be rotatable about an (n+2)th rotation axis in a axis direction parallel to the axis direction of the (n+1)th rotation axis; and
a second inertial sensor provided in the (n+2)th arm.

7. The robot according to claim 6, wherein the first inertial sensor has a detection axis in an axis direction parallel to the axis direction of the nth rotation axis.

8. The robot according to claim 7, wherein the first inertial sensor is an angular velocity sensor.

9. The robot according to claim 6, wherein the first inertial sensor has a detection axis in an axis direction different from the axis direction of the nth rotation axis.

10. The robot according to claim 9, wherein the first inertial sensor is an acceleration sensor.

11. The robot according to claim 6, wherein the second inertial sensor has a detection axis in an axis direction parallel to the axis direction of the (n+1)th rotation axis.

12. The robot according to claim 6, wherein the second inertial sensor has a detection axis in an axis direction different from the axis direction of the (n+1)th rotation axis.

13. The robot according to claim 1, wherein the first inertial sensor has a plurality of detection axes in axis directions different from one another.

14. The robot according to claim 13, wherein the first inertial sensor is a triaxial angular velocity sensor.

15. The robot according to claim 1, wherein vibrations are reduced based on output of the first inertial sensor.

16. A control apparatus controlling actions of the robot according to claim 1.

17. A control apparatus controlling actions of the robot according to claim 2.

18. A robot system comprising:
the robot according to claim 1; and
a control apparatus controlling actions of the robot.

19. A robot system comprising:
the robot according to claim 2; and
a control apparatus controlling actions of the robot.

20. A robot system comprising:
the robot according to claim 3; and
a control apparatus controlling actions of the robot.
